(19) United States
(12) Patent Application Publication
(10) Pub. No.: US 2014/0098947 A1
(43) Pub. Date: Apr. 10, 2014

(54) AD HOC MEETING INITIATION

(71) Applicant: INTERNATIONAL BUSINESS MACHINES CORPORATION, Armonk, NY (US)

(72) Inventors: Andrew D. Dingsor, Durham, NC (US); Andrew J. Ivory, Wake Forest, NC (US); Craig A. Lanzen, Durham, NC (US); James W. Lawwill, Winchester, KY (US); Brian L. Pulito, Lexington, KY (US)

(73) Assignee: International Business Machines Corporation, Armonk, NY (US)

(21) Appl. No.: 13/647,361

(22) Filed: Oct. 8, 2012

(51) Int. Cl. H04M 3/42

(52) U.S. Cl. 379/202.01

(57) ABSTRACT

Embodiments of the present invention provide a method, system and computer program product for ad hoc meeting initiation. In an embodiment of the invention, a method for ad hoc initiation of an e-meeting has been provided. The method includes establishing a proposed duration of a meeting and a list of proposed participants to the meeting. The method also includes determining presence awareness for each of the proposed participants. The method yet further includes querying calendar data in a calendar data store for each of the proposed participants to determine whether or not each of the proposed participants is available to immediately attend the meeting for the proposed duration. Finally the method includes directing initiation of the meeting only if a threshold number of the proposed participants are determined to be both present and available for the proposed duration to participate in the meeting.

### BACKGROUND OF THE INVENTION

1. Field of the Invention

The present invention relates to meeting management and more particularly to activating an ad hoc arranged meeting.

2. Description of the Related Art

A meeting is a gathering of individuals to discuss one or more agenda items, either in person or remotely. The modern age of telecommunications and data communications permits meetings to occur remotely by way of telephone, video conference or audio conference. In all cases, the conference can occur through the public switched telephone network (PSTN), a private network, the Internet, or any combination thereof. As such, the ability of individuals to congregate in a meeting to discuss agenda items is limited only by the access of individuals to a communicative device such as a mobile phone, personal computer or smart phone.

Audio teleconferencing is a collaborative meeting technology in which different individuals participate in a group meeting via telephone or voice over Internet protocol (VoIP) connection to one another. First developed nearly sixty years ago as a business tool, audio teleconferencing once was considered an extremely costly tool. Today, however, the costs of audio conferencing have been reduced to very little and in some cases, there is no cost at all. In particular, the advent of the Internet and Internet protocol (IP) telephony now permits modestly robust teleconferencing as a feature integrated into standard telephony services.

Audio teleconferencing requires the establishment of a common point of termination for all telephonic signals for all participating parties to the audio teleconference. The establishment of the common point of termination can be accomplished through the use of a teleconference bridge. A teleconference bridge receives inbound and outbound telephone signals from a local telephone switch for each of the participants to different concurrently hosted audio teleconferences. Depending upon the structure of each audio teleconference, either a passcode entered by each attendee calling the bridge routes the call signal to the correct audio teleconference, or an operator manually routes the connection into the correct audio teleconference.

As it is well known, there are two basic types of conference calls: operator dial-out services and operator dial-in services. In an operator dial-out service, an audio teleconference call is planned in advance, and a specified number of lines are provisioned to support the audio teleconference for a specific duration of time. The customer provides the conference call service with the names and telephone numbers of all parties that are to attend the session. At the appointed time, a conference operator dials out to the attendees and places the callers into a common conference line. With this approach, the conference moderator is usually connected last.

In contrast, in a dial-in conference, attendees dial a specific telephone number to connect with the conference bridge. Upon connection, an automated message prompts the caller to enter a pre-assigned passcode for the audio teleconference. Once the correct passcode is entered, the attendee is automatically routed into the call. The moderator to the teleconference, however, is allotted a separate passcode and is granted administrative privileges in respect to the management of the audio teleconference.

In both an operator dial out and a dial-in conference, the audio conference itself is organized in advance with a participant list known a priori to the organizer. Further, each participant in the list is notified of the audio conference in advance. In integrative conferencing systems, the establishment and scheduling of an audio conference is coordinated by a calendaring and scheduling (C&S) system through which invites are sent to each participant and the time scheduled for the conference call reserved in the calendars of respective invited participants. To the extent that a prospective participant already has an appointment or meeting scheduled for the time proposed for the audio conference, a conflict can be brought to the attention of the participant.

Importantly, while traditional modes of scheduling a meeting such as an audio conference are satisfactory for many ordinary circumstances, some circumstances enjoy a sense of urgency not well met by the traditional mode of scheduling a meeting. In this regard, in some circumstances, a meeting must occur almost immediately and only when a certain set of participants are available to participate in the meeting. In this circumstance, a manually intensive process of locating required participants and verifying the availability of each required participant is required before initiating the meeting.

### BRIEF SUMMARY OF THE INVENTION

Embodiments of the present invention address deficiencies of the art in respect to spontaneously initiating a meeting such as an audio conference initiation and provide a novel and non-obvious method, system and computer program product for ad hoc meeting initiation. In an embodiment of the invention, a method for ad hoc initiation of an e-meeting has been provided. The method includes establishing a proposed duration of a meeting and a list of proposed participants to the meeting. The method also includes determining presence awareness for each of the proposed participants. In this regard, in computer and telecommunications networks, presence information is a status indication that conveys ability and willingness of a potential communication partner—for example a user—to communicate. Typically, a client computing device of the end user can provide presence information, also known as presence state, via a network connection to a presence service, which is stored in what constitutes his personal availability record and can be made available for distribution to other users to convey the availability of the end user for communication.

The method yet further includes querying calendar data in a calendar data store for each of the proposed participants to determine whether or not each of the proposed participants is available to immediately attend the meeting for the proposed duration. Finally the method includes directing initiation of the meeting only if a threshold number of the proposed participants are determined to be both present and available for the proposed duration to participate in the meeting.

In another embodiment of the invention, an audio conferencing system can be configured for the ad hoc initiation of an audio conference. The system can include a host computing system that includes at least one computer with memory and at least one processor. The system also can include a conference bridge executing in the memory of the host computing system. The system yet further can include an ad hoc audio conference initiation module coupled to the conference bridge. The module can include program code enabled to establish a proposed duration of a meeting and a list of proposed participants to the meeting, to determine presence awareness for each of the proposed participants, to query calendar data in a calendar data store for each of the proposed participants to determine whether or not each of the proposed participants is available to immediately attend the meeting for the proposed duration, and to direct the conference bridge to initiate the meeting only if a threshold number of the proposed participants are determined to be both present and available for the proposed duration to participate in the meeting.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for the ad hoc initiation of an e-meeting;

FIG. 2 is a schematic illustration of an audio conferencing system configured for the ad hoc initiation of an audio conference; and,

FIG. 3 is a flow chart illustrating a process for the ad hoc initiation of an audio conference.

### DETAILED DESCRIPTION OF THE INVENTION

Embodiments of the invention provide for the ad hoc initiation of a meeting. In accordance with an embodiment of the invention, a duration of time for an ad hoc meeting such as an e-meeting or an audio conference, and a set of desired participants for the ad hoc meeting can be established. Presence awareness can be performed for each participant on the list and when a threshold number of participants indicate an immediate availability for a meeting through presence awareness, and further where calendar entries for each of the threshold number of participants indicate an availability for the meeting for the established duration of time, the meeting can be initiated in respect to the participants that are both immediately available for the meeting for the duration of time established for the meeting. In this way, an ad hoc meeting can be facilitated with nothing more than a conference organizer specifying a time and duration of a proposed meeting and a set of participants for the meeting.

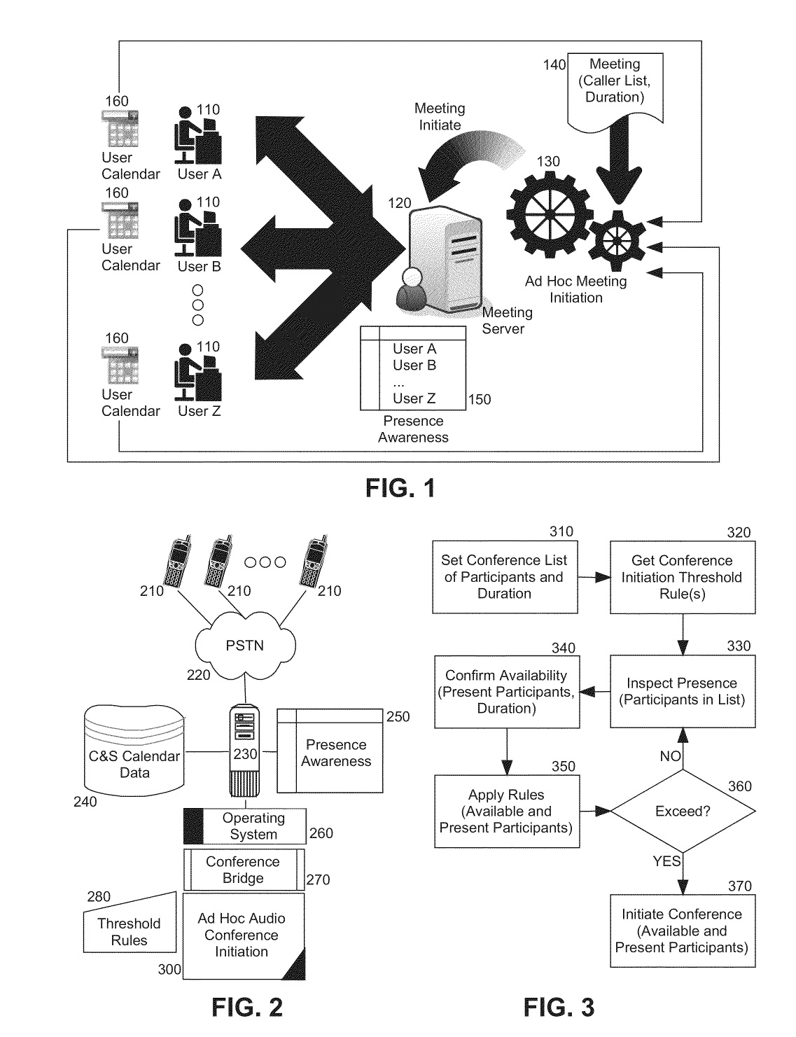

In further illustration, FIG. 1 is a pictorial illustration of a process for the ad hoc initiation of a meeting. As shown in FIG. 1, a meeting server 120 such as an e-meeting server configured to host an e-meeting, an audio conference or a chat room can be provided. Ad hoc meeting initiation logic 130 can direct the meeting server 120 to establish and host a meeting such as an e-meeting, audio conference or chat room which is to include meeting parameters 140—namely a list of participants 110 to the meeting and a proposed duration of the meeting. Ad hoc meeting initiation logic 130 in response to the receipt of the meeting parameters 140 can inspect presence awareness 150 for each participant 110 in the list of the meeting parameters 140 to determine the contemporaneous presence of the participants 110—for example, based upon the detection of each of the participants interacting with a corresponding computer coupled to the meeting server 120.

Ad hoc meeting initiation logic 130 upon determining a number of the participants 110 being present through presence awareness 150, can review a calendar 160 for each of the participants 110 to ensure that a block of time in each calendar 160 for each of the participants is available that is sufficient to accommodate the meeting of a duration set forth in the meeting parameters 140. Thereafter, when a threshold number of the participants 110 specified by the meeting parameters 140 is both present according to presence awareness 150 and also available according to the calendars 160, the meeting can be initiated, for instance in the case of an e-meeting by sending an e-mail to each of the participants with a connection hyperlink to the e-meeting, in the case of a chat session by triggering the launch of a chat window for each of the participants 110, and in the case of an audio conference by dialing out to each of the participants 110.

The process described in connection with FIG. 1 can be implemented in the specific case of an audio conference in connection with an audio conferencing system. In yet further illustration, FIG. 2 schematically shows an audio conferencing system configured for the ad hoc initiation of an audio conference. The system can include a host computing system 230 that includes one or more computers each with its own memory and at least one processor. An operating system 260 can execute within the host computing system 230 and the operating system 260 in turn can support the operation of a conference bridge 270 configured to host an audio conference for different calling telephonic devices 210 over a public switched telephone network (PSTN) 220.

An ad hoc audio conference initiation module 300 can be coupled to the conference bridge 270. The ad hoc audio conference initiation module 300 can include program code that when executed in the memory of the host computing system 230 can direct the conference bridge 270 to build in memory of the host computing system 230 a table of presence awareness 250 for different proposed participants to an audio conference and to determine from calendar data 240 for the proposed participants whether or not the proposed participants are available to participate in audio conference of a specified duration. The ad hoc audio conference initiation module 300 can additionally include program code that when executed in the memory of the host computing system 230 can direct the conference bridge 270 to initiate an audio conference amongst the proposed participants when compared to threshold rules 280, a threshold number of the proposed participants are both present and available to participate in the audio conference.

In even yet further illustration of the operation of the ad hoc audio conference initiation module 300, FIG. 3 is a flow chart illustrating a process for the ad hoc initiation of an audio conference. Beginning in block 310, a conference list of participants to an audio conference can be established as can a proposed duration of the audio conference. In block 320, one or more threshold rules can be retrieved for initiating the audio conference. For example, the rules can specify that a threshold number or percentage of specified participants must be both present and available before initiating an audio conference. In a more complex circumstance, the rules can vary in terms of number or percentage depending upon an indicating degree of urgency of the audio conference, or the time of day or day of the week or the month of the year. Yet further, the threshold rules can specify by identity or role one or more participants who must be present and available before initiating an audio conference.

In block 330, presence awareness can be determined for each of the participants in the conference list. In this regard, a computing device for each of the participants can report when a corresponding one of the participants is actively using the computing device, or when the participants are presently busy, in a meeting, away from the computing device, speaking on the telephone, etc. By way of example, an instant messaging client can determine a lapsed period of time during which an end user has not interacted with a host computing device resulting in a presence awareness state of “away”. Conversely, an instant messaging client can detect interaction between an end user and a host computing device during a threshold period of time resulting in a presence awareness state of “I am available”.

In block 340, for those of the participants determined to be present, corresponding calendars for each of the participants can be processed to ensure the availability of those present participants—namely that no appointments or meetings have been scheduled to occur within a period of time consistent with the duration of time specified for the audio conference that otherwise would cause a scheduling conflict with the audio conference. In block 350, the threshold rules can be applied to the resulting set of both available and present participants and in decision block 360, it can be determined if the rules once applied permit the initiation of the audio conference. If so, in block 370 the audio conference can be initiated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. A method for ad hoc initiation of an e-meeting, the method comprising:
establishing a proposed duration of a meeting and a list of proposed participants to the meeting in memory of a host computing system;
retrieving one or more threshold rules for initiating the meeting, wherein the rules specify that a threshold number or percentage of proposed participants or by identity or role one or more participants must be both present and available before initiating the meeting, and wherein the rules vary in terms of number or percentage depending upon an indicating degree of urgency of the meeting, or the time of day or day of the week or the month of the year;
determining presence awareness for each of the proposed participants;
querying calendar data in a calendar data store for each of participants who are determined to be present to determine whether or not each of the participants is available to immediately attend the meeting for the proposed duration;
applying the rules to the resulting set of both present and available participants; and,
directing initiation of the meeting only if the rules are satisfied.

2. The method of claim 1, wherein the meeting is an audio conference.

3-5. (canceled)

6. An audio conferencing system configured for the ad hoc initiation of an audio conference, the system comprising:
a host computing system comprising at least one computer with memory and at least one processor;
a conference bridge executing in the memory of the host computing system; and,
an ad hoc audio conference initiation module coupled to the conference bridge, the module comprising program code enabled to
establish a proposed duration of a meeting and a list of proposed participants to the meeting,
retrieve one or more threshold rules for initiating the meeting, wherein the rules specify that a threshold number or percentage of proposed participants or by identity or role one or more participants must be both present and available before initiating the meeting, and wherein the rules vary in terms of number or percentage depending upon an indicating degree of urgency of the meeting, or the time of day or day of the week or the month of the year,
determine presence awareness for each of the proposed participants,
query calendar data in a calendar data store for each of participants who are determined to be present to determine whether or not each of the participants is available to immediately attend the meeting for the proposed duration,
apply the rules to the resulting set of both present and available participants, and
direct the conference bridge to initiate the meeting only if the rules are satisfied.

7. The system of claim 6, wherein the meeting is an audio conference.

8-10. (canceled)

11. A computer program product for ad hoc initiation of an e-meeting, the computer program product comprising:
a computer readable storage medium comprising a device having computer readable program code embodied therewith, the computer readable program code comprising:
computer readable program code for establishing a proposed duration of a meeting and a list of proposed participants to the meeting;
computer readable program code for retrieving one or more threshold rules for initiating the meeting, wherein the rules specify that a threshold number or percentage of proposed participants or by identity or role one or more participants must be both present and available before initiating the meeting, and wherein the rules vary in terms of number or percentage depending upon an indicating degree of urgency of the meeting, or the time of day or day of the week or the month of the year;
computer readable program code for determining presence awareness for each of the proposed participants;
computer readable program code for querying calendar data in a calendar data store for each of participants who are determined to be present to determine whether or not each of the participants is available to immediately attend the meeting for the proposed duration;
computer readable program code for applying the rules to the resulting set of both present and available participants; and,
computer readable program code for directing initiation of the meeting only if the rules are satisfied.

12. The computer program product of claim 11, wherein the meeting is an audio conference.

13-15. (canceled)
